(19) United States
(12) Patent Application Publication
(10) Pub. No.: US 2016/0348609 A1
(43) Pub. Date: Dec. 1, 2016

(54) Cast Part and Insert for Such a Cast Part

(71) Applicant: Nemak, S.A.B. de C.V., Nuevo Leon (MX)

(72) Inventors: Henning Meishner, Wernigerode (DE); Rolf Gosch, Thalheim bei Wels (AT); Annett Bretschneider, Zwonitz (DE); Wolfgang Kühn, Lauter-Bernsbach (DE)

(73) Assignee: Nemak, S.A.B. de C.V., Nuevo Leon (MX)

(21) Appl. No.: 15/112,808

(22) PCT Filed: Jan. 20, 2015
(86) PCT No.: PCT/IB2015/000052

§ 371 Date: Jul. 20, 2016

(30) Foreign Application Priority Data
Jan. 20, 2014 (DE) 10 2014 100 568.6

(51) Int. Cl. F02F 1/24; C23D 5/02; C03C 8/14; F01D 25/24; F02B 37/00

(52) U.S. Cl. CPC F02F 1/24; F01D 25/24; F02B 37/00; C03C 8/14; C23D 5/02; F02F 2001/008

(57) ABSTRACT

The invention provides a cast part which is cast from a casting material and into which a channel is formed which gas flows through in operation, wherein the channel is at least in sections delimited by a separately prefabricated metal insert which is cast into the cast part. In order that such a cast part can withstand the highest thermal and mechanical stresses in the area of its gas-conveying channel, the invention proposes that the insert on its inner surface assigned to the gas and on its outer surface assigned to the casting material is in each case at least in sections coated in each case with a glaze or enamel coat.

The invention relates to a cast part which is cast from a casting material and into which a channel is formed which gas flows through in operation, wherein the channel is at least in sections delimited by a separately prefabricated insert which is cast into the cast part.

Such a cast part is, for example, known from DE 2 602 434 A1. The cast part in question is a cylinder head cast from an aluminium casting alloy for an internal combustion engine. The exhaust gas channel of the cylinder head is encased by a tubular insert consisting of thin sheet metal cast into the cylinder head.

In the case of the known cylinder head, the encasing of the exhaust gas channel is designed in such a way that at least in sections no direct thermally conductive contact exists between the cast material and the sheet metal material of the insert. In this way, on the one hand, the aluminium cast material is shielded from the hot exhaust gas flowing out through the exhaust gas channel of the cylinder head in use. On the other hand, the sheet metal jacket due to the restricted thermally conductive contact to the cast material surrounding it and the lower insulation associated with this reaches considerably higher temperatures than the usual cylinder head volume. As a result, a better secondary reaction of the combustion gases in the exhaust gas channel should result, which in turn should lead to a reduction in the exhaust emissions.

In order to improve the insulation of the sheet metal insert with respect to the cast material of the known cylinder head, a ceramic layer can be applied on the outside of the insert. Alternatively or additionally, it is also possible to make the sheet metal insert of the known cylinder head double-walled forming a heat-insulating air gap between the sheets.

Another possibility to restrict the heat transfer between a hot exhaust gas flowing through an outlet channel of a cylinder and the light metal cast material of the cylinder is explained in DE 37 11 433 A1 using the example of a cylinder for a two-stroke engine. According to this prior art, the outlet channel is lined with a ceramic part which has a considerably reduced thermal conductivity than a light metal cast.

Furthermore, it is known from DE 10 2010 025 286 A1 that the inner surfaces of exhaust gas channels of light metal cast parts for internal combustion engines, such as cylinder heads, can be effectively protected against excessive thermal stress by at least in sections coating them with a coating which consists of a glass material. The practical application of this proposal produces a particular challenge due to the fact that the coating, on the one hand, has to reliably withstand the mechanical and thermal stresses occurring in operation and, on the other hand, has to allow mechanical processing of sections of the respective component abutting on the coated surface section without the risk of the coating flaking.

Against the background of the prior art explained above, the object of the invention was to improve a cast part of the type explained above in such a way that it also reliably withstands the highest thermal and mechanical stresses in the area of its gas-conveying channel. In addition, a means should be specified which also in a simple way makes it possible to toughen up cast parts of the type explained at the outset for this purpose.

This object has been achieved with regard to the cast part according to the invention by the formation of such a cast part specified in claim 1.

With regard to the means, the above specified object is achieved according to the invention by an insert formed according to claim 9.

Advantageous embodiments of the invention are specified in the dependent claims and like the general concept of the invention are explained in detail below.

A cast part according to the invention is accordingly cast from a casting material and has a channel which gas flows through in operation which is at least in sections delimited by a separately prefabricated insert which is cast into the cast part. According to the invention, the insert provided for a cast part according to the invention on its inner surface assigned to the gas and on its outer surface assigned to the casting material is in each case at least in sections coated in each case with a glaze or enamel coat.

In the understanding of the invention, coats which are formed from inorganic compounds which consist of oxides fused together, such as SiO₂, Al₂O₃, B₂O₃, Li₂O, Na₂O etc., fall within the scope of the term “glaze or enamel coat”. The coats can additionally contain inorganic or organic compounds in the form of fibres, such as SiC fibres or C fibres. When glaze or enamel coats are produced the pre-fused compounds are ground up with water. Subsequently, the fibres are optionally admixed. The slip respectively obtained in this way is applied onto the insert and burned in to form the respective glaze or enamel coat.

The glaze or enamel coat according to the invention applied onto the inner surface of the insert swept over by gas in use protects the insert against a chemical attack or thermal stress by the gas to which the inner surface in question is exposed in use. In this way, the glaze or enamel coat can constitute a protection against corrosion which protects the insert against a chemically aggressive gaseous medium.

Alternatively or additionally, the glaze or enamel coat can also form a heat-protection shield, by means of which the excessive heating of the insert can also be prevented when a very hot gas flows against the insert in operation.

The application typical for this is a cylinder head produced as a cast part for an internal combustion engine, into the exhaust gas channel of which an insert coated according to the invention is cast. Equally, the invention can also be suitable for a housing for a turbocharger which is arranged in the exhaust gas flow of an internal combustion engine and whose channel flowed through by exhaust gas is allocated an insert coated according to the invention.

The glaze or enamel coat arranged on the outer surface of the cast part facing the casting material, on the one hand, ensures that the respective insert is optimally bound to the casting material. In this way, the glaze or enamel coat adheres firmly to the substrate formed by the insert and on its free outer face provides a joining surface, via which a firm join between the casting material and the insert can be produced. In order to increase the heat insulation of the coat, substances can be mixed in which burn during the casting-in process. The gases arising as combustion products form many small pockets and channels filled with gas in the glaze or enamel coat, the presence of which lowers the thermal conductivity of the coat and as a consequence thereof increases the heat-insulating effect. The insulating effect can be further supported by using steel or other poorly heat-conducting materials for producing the base substrate of an insert according to the invention. On the other hand, the outer coat applied according to the invention also forms a thermal insulation between the insert and the surrounding cast material, by means of which the flow of heat from the insert into the cast material is interrupted. If the insert according to the invention is provided in a cast part in which in use a hot gas flows against its inner surface, then the glaze or enamel coat according to the invention provided on the outer surface of the insert consequently causes the cast material to be considerably less heated in the surrounding area of the insert than would be the case if hot gas flowed directly against it.

A further advantage of the invention is that an insert according to the invention, in the case where its base body carrying the respective coats is produced from metal, can be formed considerably thinner or from a weaker material due to the protective effect of the glaze or enamel coats applied onto it than in the case where it would be directly exposed to the effect from the gas.

In particular, in the case of a design of a cast part according to the invention, no elaborate e.g. double-walled sheet metal designs or other design features are necessary any longer, in order to obtain the desired heat-insulating effect by forming an air gap between the channel to be shielded in each case and the cast material of the cast part.

Instead, the insert to be cast into the cast part according to the invention can be a simple component, the base body of which can be formed, for example, from a sheet metal blank by means of a suitable conventional forming process or can be produced in any other suitable way. Thus, in the case of a complex design of the channel of the cast part to be shielded by the insert for example, it can be advantageous for the base body of the insert to be formed in a forming process, for example by casting, forging, extruding or suchlike. Each of the production methods mentioned enables tubular inserts to be produced which fully encase the channel to be protected in each case.

A thermally particularly highly stressable embodiment of the invention results if the base body of the insert consists of a metal material which has a higher melting temperature range than the metallic casting material, from which the cast part is cast. Thus, in particular a heat-resistant, corrosion-resistant steel is suitable for producing the base body of the insert. In the case of production from sheet metal, it can be advantageous depending on the respective complexity of the course and the shape of the cast part channel to be respectively protected if the sheet metal formed part is composed of two or more individual parts.

If an insert with a particularly low weight is provided for the purpose according to the invention, then the base body of the insert can, for example, also be produced from a metal foam, in particular from a light metal foam. In addition to its minimized weight effect.

With respect to the production of such cast parts, in which the channel to be protected in each case is directly coated with a protective coat on its inner surface, the invention has the significant advantage that the insert according to the invention is not only preformed separately, but can also already be provided with the coatings provided according to the invention before it is cast into the cast part. Correspondingly, the coating process can also be carried out in a simple way in manufacturing plants specialised in this without regard for possibly negative effects which the production steps required for producing the coating could have on the cast part. This proves to be advantageous particularly in light of the fact that the coats provided as a coating according to the invention usually have to be burned in at comparatively high temperatures, in which the microstructure of the cast part can already be affected. Using the method according to the invention by way of a pre-coated insert which is then cast into the cast part, the advantages of coats can be utilised without this risk.

Therefore, the invention is particularly suitable for cast parts which consist of a light metal or a light metal alloy. Thus, in particular cast parts for use under thermally and mechanically highly stressed conditions can be toughened up in the manner according to the invention. The cast parts constituted according to the invention are accordingly in particular cylinder heads, turbocharger housings and comparable components of internal combustion engines, in which in particular the channels of these cast parts conveying hot gas can be protected in a manner according to the invention by in each case providing a coated insert in a manner according to the invention in the area of the respective hot gas channels.

The coatings applied onto the inner and outer surfaces of the insert according to the invention are typically glazes or enamel coatings. The respective coating material should be selected taking into account the material from which the insert to be coated is manufactured. If the insert consists of a light metal material, then an aluminium enamel can be used which has coarse admixtures of e.g. corundum, quartz, silicon carbide or tungsten oxide in contents of 1-20% wt. If, on the other hand, the insert consists of a steel material, then steel enamels can be used which also have admixtures of fire-proof materials, such as Cr₂O₂, SiO₂, Al₂O₂, WO₃ in contents of 1-20% wt. In order to increase the thermal shock resistance, the enamels used in each case can also here contain 0.2-10% wt. of fibres of inorganic or organic composition.

Practical tests have surprisingly shown with respect to the coating of the outer surface of the insert according to the invention that an intensive firmly bonded binding of the casting material to the coating firmly adhering to the insert results if an enamel is used as the coating material and a conventional aluminium casting alloy is used as the casting material. Here, intermetallic phases appear to form between the coating material and the casting material which ensure that the casting material firmly adheres to the coating material and as a consequence thereof via the join produced by the coating material in the same way ensure that the insert is firmly fixed in the cast part.

In the case where an enamel is to be used for the coating of the inner surface, an enamel which has been produced in a conventional manner based on a glass powder is suitable for this purpose. If the insert protecting the respective channel of the cast part has been produced from a light metal material, then an aluminium enamel, to which boric acid, caustic potash and water glass are added and which can contain the fire-proof materials already listed above, is ground together with water to form a usable slip. If, on the other hand, the insert is produced from a steel material, then in addition to the fire-proof materials clay and small amounts of electrolytes and water are also added to the steel enamel and the slip formed from these is in the usual way applied onto the insert and burned in. In addition to silicate enamels, phosphate enamels, zirconium enamels or variations thereof can be used for the purposes according to the invention. For 100 parts of glass frit, 10-21 parts of corundum or a corresponding amount of a substance with a comparably high melting point can be added to the glass powder used in each case, in order to maximise the heat resistance of the coating of the inner surface.

When “parts” are mentioned as the dosing measure here, it is understood by this that the amount of the respective constituent added to the enamel powder is measured by means of a unit measure which is the same for all constituents and the “parts” respectively provided for individual constituents according to the invention indicate the respective multiple of this unit measure.

A powder suitable for producing such an enamel coat is described in the as yet unpublished German patent application DE 10 2013 108 429.1, the content of which is included here in the disclosure of the present invention. The enamel powder specified in the German patent application in question is particularly suitable for coating metallic surfaces which are thermally and mechanically highly stressed in operation and is present as a mixture which contains 100 parts of a glass powder, optionally 10-22 parts of coarse glass granulates, which are larger than the particles of the glass powder, 0.1-7.5 parts of ceramic fibres, glass fibres or carbon fibres and alternatively to one another or in combination with one another 10-21 parts of an oxidic compound of a light metal present in powder form or 1-5 parts of a powder of a heavy metal.

As described in the German patent application, the following importances are attached to the individual constituents of the enamel powder according to the invention:

### a) Glass Powder

The glass powder is the basis of the enamel powder in question and, in the case of the enamel coating constituted according to the invention and produced on the respective surface section of the metal component, forms the matrix in which the other constituents of the enamel powder are embedded.

The types of glass customarily used for this purpose in the prior art can be used as glass powder. Glass powders consisting of types of glass which have a lower coefficient of expansion than the base material on which the surface section is present which in each case is to be coated with the enamel coating formed by the enamel powder are suitable for the invention. In order to prevent damage to or deformation of the respective metal substrate in the course of burning-in the enamel coating, the glass powder produced from such types of glass should melt at a temperature which is lower than the temperature range in which the melting temperature of the respective base material lies.

In the case of applications on surfaces of internal combustion engine components which are produced from light metal casting and in use are exposed to a hot exhaust gas flow, it has become apparent that an enamel coating produced based on such glass powders and otherwise composed also then still reliably withstands the thermal and mechanical stresses and reliably protects the light metal substrate if the exhaust gas temperature lies very much higher than the melting temperature of the casting material and the enamel coating itself. Typical possible melting temperatures of the glass powder on application on surface sections of light metal components are in the range from 500-650° C., in particular 540-580° C. The grain size (average diameter) of the particles of the glass powder forming the basis of such an enamel powder is typically in the range from 5-40 μm, wherein glass powders with a grain size which on average is 25 μm have proved to be particularly suitable in practice.

### b) Coarse Glass Granulates

10-22 parts of coarse glass granulates can optionally be added to such an enamel powder in order to provide the enamel coating produced from the enamel powder with further improved resistance to crack formation. Those glass particles which are larger than the largest particles of the glass powder which forms the basis of the enamel powder are referred to as “coarse glass granulates”. Typically, therefore, glass granulates with an average diameter of more than 40 μm are included here. At the same time, the average diameter of the coarse glass granulates should not exceed 500 μm, in order to guard against coarsening the coating produced with such an enamel powder too coarse too strongly.

Due to their comparably large volume the coarse glass granulates do not completely melt when the enamel coating is burned in, but remain intact in their basic structure. If cracks form in the enamel coating in practical use, then the glass granulates present in the enamel coating oppose the further spread of the cracks in the manner of a barrier which cannot be overcome by the respective crack. In this way, the further progression of the crack is effectively counteracted and further damage to the coating is prevented.

Glass pieces which are composed like the above mentioned enamel powder can be used as coarse glass granulates. The coarse glass granulates produced from such an enamel powder then have a composition and properties which correspond to the composition and properties of a coating produced from the enamel powder in question. In this way, it is ensured that the coating produced according to the invention despite the presence of coarse glass granulates has homogeneous properties to the greatest possible extent and a likewise uniform behaviour. Those coarse glass granulates which are already added as frits in the course of producing enamel powder of the kind mentioned here have proved to be particularly suitable for such an enamel powder. Such fritted, i.e. not quite fused, glass granulates have proved to be particularly effective in relation to preventing larger crack formation in enamel coatings produced by the enamel powder.

The enamel powder contains 10-22 parts of these glass granulates, so that the effect of the coarse glass granulates occurs with the desired reliability, wherein an optimum effect occurs if at least 15 parts of coarse glass granulates are added to the enamel powder.

### c) Ceramic Fibres, Glass Fibres or Carbon Fibres

A special importance is attached to the fibres present in an above mentioned enamel powder. They ensure that an enamel coating formed from the powder also holds together under the high stresses which can result due to variations in temperature and mechanical pressure loads occurring in practical use.

In order to fulfil this function, 0.1-7.5 parts, in particular at least 2 parts or at least 3.5-7.5 parts, of ceramic fibres, glass fibres or carbon fibres are present in an enamel powder of the type referred to here, wherein the ceramic fibres, glass fibres and the carbon fibres can in each case be added alone or also as a mixture. Optimum effects are produced if 4-6 parts of fibre material are present in the powder.

Basically, ceramic fibres, glass fibres or carbon fibres with a fibre length of 10-9000 μm are considered for the enamel powder. A long fibre length has proved to be favourable with regard to the cohesion of the enamel coating formed from an enamel powder, but can impair the workability. With a fibre length of less than 10 μm the reinforcing effect is too weak. Fibres which have a length of 10-1000 μm have proved to be sufficiently effective and at the same time guaranteeing good workability.

Commercially available fibres can be used as carbon fibres. The same applies for the ceramic fibres and glass fibres, wherein here, by way of example, SiC fibres or glass fibres of different compositions can be mentioned.

### d) Oxidic Compounds of a Light Metal or Powder of a Heavy Metal

Oxidic compounds of a light metal present in powder form or powder of a heavy metal can, at the same time or alternatively, be present in the enamel powder, in order to shift the melting temperature of the coating formed from the enamel powder into ranges which are not critical with regard to the respective application purpose.

In this way, enamel coatings can also be produced on light metal components, which are formed with uncritical burning-in conditions with regard to the melting temperature of the respective light metal material, but which in practical use are heat resistant such that they can reliably withstand the maximum temperatures which occur.

In order to achieve this effect, the enamel powder contains 10-21 parts, in particular 12-17 parts, of an oxidic compound of a light metal present in powder form and/or 1-5 parts, in particular 2-4 parts, of a powder of a heavy metal.

Here, “light metals” are understood as metals with a density of less than 5 g/cm³. Al, Ti and Mg are in particular included among these.

From the oxides of these light metals, Al oxides are particularly suitable for use in the enamel powder due to their high melting points of more than 2000° C. However, particularly with a coating of light metal components, other light metal oxide powders, such as powder from Ti oxide and suchlike, can be also used, the melting points of which are still more than 1000° C. and are hence clearly above the melting temperature range of the light metal substrate.

Optimum influences of the respectively provided light metal oxides on the properties of an enamel coating produced from the enamel powder occur if the light metal oxides are present in amounts of up to 30% based on the amount of the amorphous coating material formed from the enamel powder.

All metals and their alloys which have a density of at least 5 g/cm³ are regarded as “heavy metals” here. All iron-based materials, in particular metal powders from alloyed steels, are included among these here. Metal powders which consist of high-grade steel, such as the steels X5CrNi18-10 and X5CrNiMo17-12-2 known under the designations “V2A” and V4A″ and standardised under the material numbers 1.4301 and 1.4401, have proved to be particularly suitable. It has also proved to be advantageous here if the melting point of the respective metal powder is more than 1000° C., so that no change in the properties of the metal powder occurs during the burning-in process.

Optimum influences of the metal powder on the properties of an enamel coating produced from the enamel powder occur if the metal powders of the heavy metals or their alloys are present in amounts of up to 10% based on the amount of the amorphous coating material.

The average diameter of the grains added to the enamel powder of the respective metal powder or of the oxides of a light metal in each case in powder form should typically be in the range from 10-500 μm.

### e) Other Constituents

In addition to the above mentioned constituents, of course optionally other additives can be present in the enamel powder, as are typically required for producing an enamel coat. Boric acid, caustic potash, water glass or demineralised water, for example, are included among these here.

In principle, the inner coating and the outer coating of an insert according to the invention can be formed the same. This can be advantageous if a coating is available which, on the one hand, is sufficiently resistant to withstand the attacks emanating from the gas flowing through the channel to be protected in each case and, on the other hand, ensures that the casting material binds well with, at the same time, an insulating effect.

However, in many cases, it is advantageous to form the coating assigned to the inner surface of the channel differently than the coating which is arranged on the outside of the insert according to the invention. In practice, this can be achieved by the coats on the inner and outer surfaces of the insert being different in terms of their composition or their structure.

Different properties of the coatings provided according to the invention on the inner and outer surfaces of the insert can in particular make sense if the gas flowing through the channel is hot and the coating provided on the inner surface is to have a high thermal and mechanical resistance, whereas the glaze or enamel coat applied onto the outer surface of the insert is to have an optimum insulating effect.

For application cases, in which a high insulating effect of the outside of the coating assigned to the casting material is required, it has proved advantageous if the glaze or enamel coat provided on the outer surface is purposefully provided with a high porosity. The gas bubbles or gas-filled channels then enclosed in the outer surface ensure that the outer coat has a high insulation value. By forming the outer coat in the area of its outer surface coming into contact with the casting material at least in sections open-pored, the insert can be bound to the surrounding casting material in an optimum way. This casting material penetrates into the open pores during the casting-in process, so that an intensive firmly bonded interlocking of the casting material to the coating material firmly adhering to the insert is obtained.

A particularly cost-effective possibility for the coating of an insert according to the invention occurs if the base body of the insert consists of at least two parts which are independent from one another and which are each coated with the glaze or enamel coats independently from one another and are subsequently combined to form the insert. By splitting the insert into two or more parts, the accessibility, in particular of the inner surfaces of the insert is made easier for the coating process, so that a uniform application of the glaze or enamel coating can be carried out in a rapid and uncomplicated way.

The invention is explained in more detail below with the aid of a drawing illustrating an exemplary embodiment:

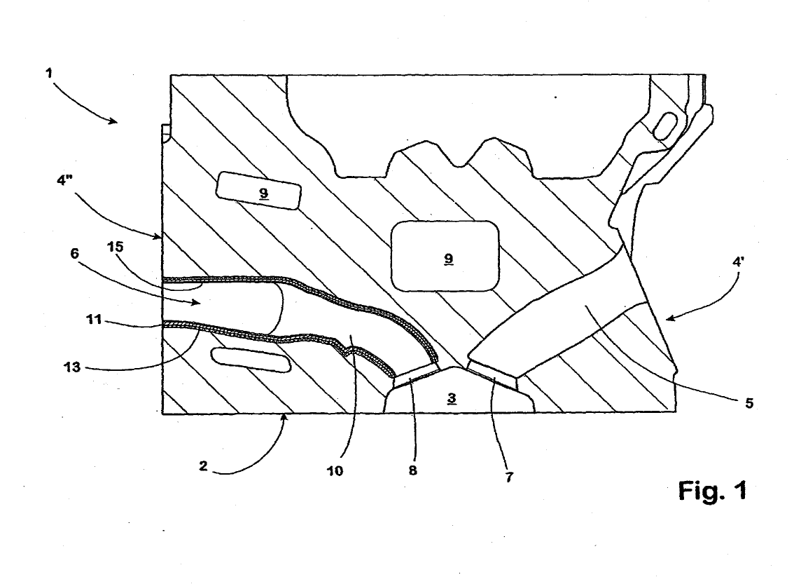

FIG. 1 schematically shows a detail of a cylinder head in a section aligned transverse to the longitudinal extension of the cylinder head;

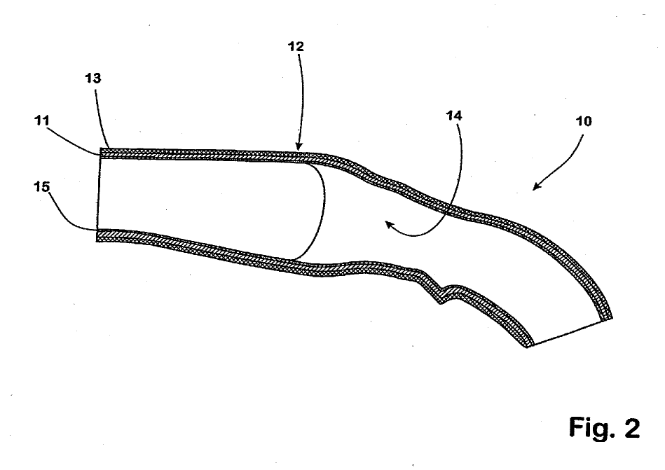

FIG. 2 schematically shows an insert provided for casting into the cylinder head according to FIG. 1 in a sectional view corresponding to FIG. 1.

The cylinder head 1 cast from an aluminium casting material usually used for these purposes, for example an AlSi alloy, for a spark ignition engine or a diesel engine has a flat contact surface 2, with which it in use rests on an engine block of the respective internal combustion engine which is not illustrated here via a cylinder head gasket which is inserted as appropriate in between and is also not shown here. The internal combustion engine has combustion chambers arranged in series and pistons which are moved up and down inside them and are likewise not visible here.

Many dome-like shaped recesses 3 corresponding to the number of cylinders of the internal combustion engine are formed into the contact surface 2, these dome-like shaped recesses 3 forming the upper termination of the combustion chambers of the internal combustion engine in the stroke direction of the pistons of the internal combustion engine.

An inlet channel 5 led from the one longitudinal side 4′ (inlet side) of the cylinder head 1 opens into each recess 3, and via which in operation the respective fuel-air mixture is admitted into the combustion chamber. At the same time, an outlet channel 6 exits from the respective recess 3 and leads to the opposite longitudinal side 4″ (outlet side) of the cylinder head 1 and via which the exhaust gas arising during the combustion process is discharged from the combustion chamber of the internal combustion engine. The opening 7 of the inlet channel 5 and the entrance opening 8 of the outlet channel 6 are opened or closed dependent on the progress of the combustion process in a manner known per se by a valve in each case. The valves in question are not illustrated here for the sake of clarity. A seat for the valves which are not illustrated is in each case in a manner known per se formed into the area of the opening 7 and the entrance opening 8.

In order to dissipate the heat which arises in operation as a result of the combustion process, the cylinder head 1 is also in a manner known per se traversed by cooling channels 9, through which coolant flows in operation.

The outlet channel 6 which hot exhaust gas flows through when the internal combustion engine is in operation is encased by a tubular insert 10 which is cast into the cylinder head 1 and which on one side leads to the valve seat at the entrance 8 of the outlet channel 6 and to its exit on the longitudinal side 4″.

The base body 11 of the insert 10 is composed of two or more sheet metal parts which are welded together in a conventional way and which have been formed, also in a conventional way, by means of a deep drawing operation from corresponding sheet metal blanks. Alternatively, the base body 11 of the insert 10 can, for example, also be produced from a tubular raw sheet metal part which has been brought into the required shape by internal high pressure forming or suchlike. The sheet metal material which the base body 11 of the insert 10 consists of can consist of a heat-resistant mechanically highly stressable steel which has been processed into sheet metal in the usual manner by hot and cold rolling. The thickness of the sheet metal material is typically 0.4-1.2 mm, in particular up to 0.9 mm.

The insert 10 carries a silicate coat 13 on its outer surface assigned to the casting material, this silicate coat 13 fully covering the base body 11 of the insert 10 over its entire length and circumference. The inner surface 14 of the base body 11 of the insert 10 is equally coated with a silicate coat 15. Both the coat 13 present on the outer surface 12 and the coat 15 present on the inner surface 14 are enamel coats. The coats 13, 15 are each formed from an enamel slip which has been applied with a thickness of 200-900 μm, in particular 400-500 μm, and has been subsequently burned in the still wet state at a burning-in temperature of 520-550° C. to form the respective coat 13, 15. The coats 13, 15 can be applied at the same time by dipping the base body 11 into a slip bath or successively and independently of one another onto the respective inner surface 14 and outer surface 12.

Ideally, the enamel slip is applied without any pre-treatment. If the state of the surface of the base body 11 does not allow this, a surface treatment of the base body 11 can precede the application of the enamel slips, in which the inner surface 14 and the outer surface 12 are thermally or chemically degreased and subsequently chemically passivated. If necessary, additionally, by means of a targeted roughening of the inner surface 14 and outer surface 12, oxide layers present there are broken up. These can in particular be present there if the base body 11 is not manufactured from a steel sheet but, for example, from an aluminium sheet.

In order to produce the enamel slip provided for producing the coat 13 on the outer surface 12
100.0 parts of glass powder, the glass particles of which have an average diameter of 10 μm,
1-5 parts of carbon black,
2 parts of boric acid,
1 part of caustic potash,
1 part of water glass,
47 parts of water,
   are ground together to form the enamel slip.

In order to produce the enamel slip provided for producing the coat 15 on the outer surface 14, on the other hand,
100.0 parts of a conventional aluminium enamel frit, 5-7 parts of corundum with an average diameter of 50 μm,
4-6 parts of a high-grade steel powder with an average diameter of 10 μm,
2 parts of boric acid,
1 part of caustic potash,
1 part of water glass,
2-5 parts of carbon fibres,
55 parts of water
   were processed together in a porcelain mill to form an enamel slip.

The individual components of the respective enamel slip were, for example, jointly ground together, wherein by choosing the moment for adding the respective component taking the material properties into account, the grain size was determined which the respective component had at the end of the grinding process.

The enamel slips were applied onto the respectively assigned outer surface 12 and inner surface 14 of the base body 11. The burning-in process subsequently took place.

Due to the content of bubble-forming components, the obtained coat 13 had pores on the outer surface 12 of the base body 11 which guarantee optimum heat insulating properties for the coat 13. The pores which are present near the free outer face of the coat 13 and are close to the surface were open. The coat 15 formed on the inner surface 14, on the other hand, had a high melting range due to its fire-proof constituents, so that it can reliably withstand the high thermal stresses to which it is exposed by the hot exhaust gas flowing against it in operation. The insert 10 correspondingly shields the cast material of the cylinder head 1 surrounding it from excessive heating and, at the same time, ensures that the exhaust gas leaves the cylinder head 1 at a high temperature.

### REFERENCE SYMBOLS

1 Cylinder head
2 Contact surface
3 Recesses
4′ Longitudinal side (inlet side) of the cylinder head 1
4″ Longitudinal side (outlet side) of the cylinder head 1
5 Inlet channel
6 Outlet channel
7 Opening of the inlet channel 5
8 Entrance opening of the outlet channel 6
9 Cooling channels
10 Insert
11 Base body
12 Outer surface of the base body 11 of the insert 10
13 Silicate coat on the outer surface 12
14 Inner surface of the base body 11 of the insert 10
15 Silicate coat on the inner surface 14

1. A cast part which is cast from a casting material and into which a channel is formed which gas flows through in operation,
wherein the channel is at least in sections delimited by a separately prefabricated metal insert which is cast into the cast part,
wherein the insert on its inner surface assigned to the gas and on its outer surface assigned to the casting material is in each case at least in sections coated in each case with a glaze or enamel coat.

2. The cast part according to claim 1, wherein the glaze or enamel coats on the inside and outside of the insert are different.

3. The cast part according to claim 1, wherein the coat in each case provided on the outer surface of the insert has pores.

4. The cast part according to claim 3, wherein the casting material during casting of the insert has penetrated into pores of the coat on the outer surface.

5. The cast part according to claim 1, wherein the insert is tubular.

6. The cast part according to claim 1, wherein the cast part is a cylinder head for an internal combustion engine and the insert is assigned to a channel of the cylinder head which conveys exhaust gas.

7. The cast part according to claim 1, wherein the cast part is a housing for an exhaust gas turbocharger, and the insert is assigned to a channel of the housing which conveys exhaust gas.

8. The cast part according to claim 1, wherein the casting material is a light metal casting material.

9. An insert for use in a cast part according to claim 1, wherein both the inner surface of the insert assigned to the channel which gas flows through, and the outer surface of the insert assigned to the casting material of the cast part are at least in sections coated with a glaze or enamel coat.

10. The insert according to claim 9, wherein the coat provided on the outer surface of the insert consists of a porous enamel.

11. The insert according to claim 10, wherein the coat is open-pored on the outer surface of the insert.

12. The insert according to claim 9, wherein the coat provided on the inner surface of the insert consists of an enamel which contains a high-temperature resistant constituent.

13. The insert according to claim 9, further comprising a base body consisting of a light metal material carrying the glaze or enamel coats.

14. The insert according to claim 13, wherein the base body consists of a light metal foam.

15. The insert according to claim 9, further comprising a base body consisting of at least two parts which are independent from one another, which are coated with the glaze or enamel coats in each case independently from one another and are subsequently combined to form the insert.
